(19) United States
(12) Patent Application Publication
(10) Pub. No.: US 2009/0253283 A1
(43) Pub. Date: Oct. 8, 2009

(54) CABLE CONNECTOR ASSEMBLY FOR EQUIPMENT CONNECTION AND EQUIPMENT CONNECTION UNIT FOR THE SAME

(76) Inventors: Sei-Hoon Cho, Ansan-si (KR); Bok-Hee Youn, Nam-gu (KR); Yong-Joon Noh, Anyang-si (KR); You-Min Kim, Anyang-si (KR)

Correspondence Address: SHERR & VAUGHN, PLLC, 620 HERNDON PARKWAY, SUITE 320, HERNDON, VA, 20170, US

(21) Appl. No.: 12/418,453

(22) Filed: Apr. 3, 2009

(30) Foreign Application Priority Data
Apr. 4, 2008 (KR) 10-2008-0031607

(51) Int. Cl. H01R 13/52; H01R 13/62

(52) U.S. Cl. 439/271; 439/345

(57) ABSTRACT

The invention relates to a cable connector assembly for equipment connection, including a cable connector having a connector housing for receiving a cable and a restraining part formed along an outer periphery of the connector housing; and an equipment connection unit having a frame body assembled with the connector housing while surrounding the connector housing, an engaging part engaged with the restraining part of the cable connector, and a fastening means formed in the frame body and configured for connection with an equipment, wherein the equipment connection unit provides a flange function when the cable connector assembly is connected with the equipment.

The cable connector assembly can provide connection between a cable and an equipment as well as between cables. Therefore, the present invention eliminates the need that a connector for a cable and a connector for equipment connection should be manufactured separately, thereby considerably reducing the connector manufacturing costs.

### FIELD OF THE INVENTION

The present invention relates to a cable connector assembly for equipment connection and an equipment connection unit for the same, and in particular, to a cable connector assembly for equipment connection that is connected to an equipment in the structure of mounting, and an equipment connection unit for the same.

### BACKGROUND OF THE INVENTION

Generally, vehicles are provided with various electronic subassemblies. An electronic subassembly is electrically connected to another subassembly or a power source through a cable. This direct connection through a cable causes a complicated and long operation. Thus, generally a connector is used to electrically connect an electronic subassembly to another subassembly or a power source.

The connector is composed of a pair of male and female connectors, and each of the female connector and the male connector has a terminal connected to an end of a cable, and an outer housing for surrounding the terminal to protect the terminal. And, a central core left by peeling off an insulating coating of the cable is inserted into a back portion of the terminal, so that the male/female connector is connected to the cable. Then, the female connector is connected with the male connector. In this way, connection is established between cables or a cable and an equipment.

The connector is divided into a connector for a cable and a connector for equipment connection according to purpose of use. The connector for a cable is used to electrically connect a cable to a cable, and the connector for equipment connection is used to electrically a cable to an equipment.

Unlike the connector for a cable, the connector for equipment connection further includes an equipment connection means for securing and affixing the connector to the equipment.

Generally, the equipment connection means is integrally formed with and extends from the outer housing of the connector. Due to the equipment connection means, the connector for equipment connection has disadvantages of a complicated manufacturing process and high manufacturing costs.

The connector for equipment connection may be used to connect a cable to a cable, but it is not economical when compared with the connector for a cable. For this reason, connector manufacturers separately manufacture a connector for equipment connection and a connector for a cable. In this case, it needs to design and produce at least two molds, which increases the costs required for mold design and production.

### SUMMARY OF THE INVENTION

The present invention is designed to solve the above-mentioned problems. Therefore, it is an object of the present invention to provide a cable connector assembly for equipment connection that can be used to establish connection between a cable and an equipment as well as between cables, and an equipment connection unit for the same.

In order to achieve the object of the present invention, a cable connector assembly for equipment connection includes a cable connector having a connector housing for receiving a cable and a restraining part formed along an outer periphery of the connector housing; and an equipment connection unit having a frame body assembled with the connector housing while surrounding the outside of the connector housing, an engaging part engaged with the restraining part of the cable connector, and a fastening means formed in the frame body and configured for connection with an equipment, wherein the equipment connection unit provides a flange function when the cable connector assembly is connected with the equipment.

In the present invention, the restraining part may have a flange or stepped structure protruding along the outer periphery of the connector housing, and the engaging part may have a stepped structure formed along an inner periphery of the frame body so that the flange or stepped structure of the restraining part can be fitted into the engaging part. And, the frame body may be formed to have a square periphery, and the fastening means may be a through-hole, through which a bolt is inserted, formed at each corner of the frame body.

The cable connector according to the present invention may further have a sealing member located between the restraining part and the equipment when the cable connector assembly is connected with the equipment.

According to another aspect of the present invention, an equipment connection unit is assembled with a cable connector including a connector housing for receiving a cable and a restraining part formed along an outer periphery of the connector housing to provide a flange function, and includes a frame body assembled with the connector housing while surrounding the outside of the connector housing; an engaging part engaged with the restraining part of the cable connector; and a fastening means formed in the frame body and configured for connection with an equipment.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is an exploded perspective view of a cable connector assembly for equipment connection according to a preferred embodiment of the present invention.

FIG. 2 is an assembled perspective view of FIG. 1.

### DETAILED DESCRIPTION OF THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the invention, so it should be understood that other equivalents and modifications could be made thereto without departing from the spirit and scope of the invention.

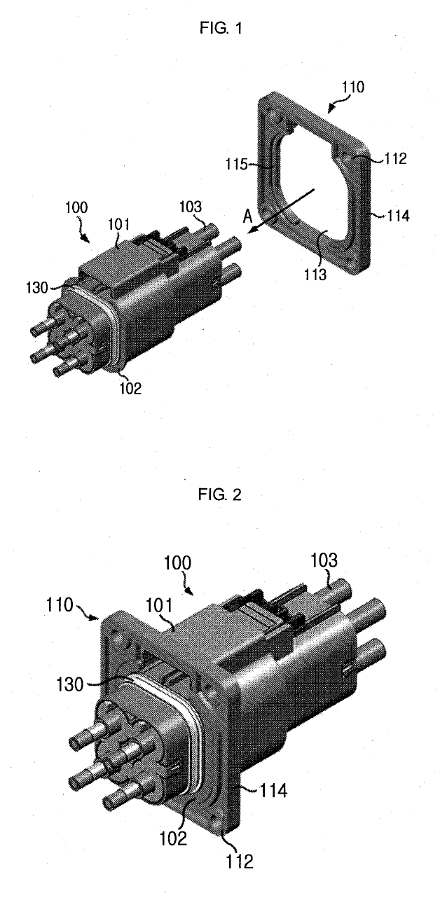

FIG. 1 is an exploded perspective view of a cable connector assembly for equipment connection according to a preferred embodiment of the present invention. FIG. 2 is an assembled perspective view of FIG. 1.

Referring to FIGS. 1 and 2, a cable connector assembly for connecting a cable to an equipment includes a cable connector 100 and an equipment connection unit 110.

The cable connector 100 includes a connector housing 101 for receiving and fixing at least one cable or terminal 103 therein, and a restraining part 102 formed of a flange or step and protruding along an outer periphery of the connector housing 101. When the cable connector 100 is assembled with the equipment connection unit 110, the restraining part 102 prevents the equipment connection unit 110 from separating from the cable connector 100.

The equipment connection unit 110 is configured to secure the cable connector 100 to the equipment, and has a frame body 114, an engaging part 115, and a fastening means 112.

The frame body 114 has a hollow 113 for receiving the connector housing 101 of the cable connector 100.

The engaging part 115 may be formed around the hollow 113, and when the equipment connection unit 110 is assembled with the cable connector 100, the engaging part 115 is engaged with the restraining part 102 of the cable connector 100. At this time, the engaging part 115 has preferably a stepped structure formed along an inner periphery of the hollow 113 so that the flange or stepped structure of the restraining part 102 can be fitted into the engaging part 115.

The fastening means 112 is configured for connection with the equipment. As shown in FIG. 1, the fastening means 112 is preferably formed of a through-hole, through which a bolt is inserted, and arranged at each corner of the frame body 114 with a square periphery. At this time, a bolt (not shown) is inserted through the through-hole 112 into the equipment.

Hereinafter, an assembly process of the cable connector 100 and the equipment connection unit 110 is described in detail with reference to FIGS. 1 and 2.

As mentioned above, the restraining part 102 of a flange structure is formed along the outer periphery of the connector housing 110. When the cable connector 100 is assembled with the equipment connection unit 110, the restraining part 102 is engaged with the engaging part 115 of the equipment connection unit 110.

More specifically, when assembly proceeds in the direction of A in FIG. 1, the restraining part 102 formed along the outer periphery of the connector housing 110 is snappingly engaged with the corresponding engaging part 115 formed around the hollow 113 of the equipment connection unit 110. At this time, the engaging part 115 is formed of a step structure, and the restraining part 102 is fitted into the step structure of the engaging part 115.

Subsequently, the equipment is bolted by inserting a bolt through the through-hole 112 arranged at each corner of the equipment connection unit 110 to secure the cable connector 100 to the equipment. Here, the frame body 114 of the equipment connection unit 110 substantially provides a flange function for connecting the cable connector assembly with the equipment.

Meanwhile, although the present invention has the restraining part 102 specially formed for assembly with the equipment connection unit 110, a conventional connector may be manufactured in the structure of a flange or step. And, the snapping engagement structure is very simple, and thus the equipment connection unit 110 may be manufactured in accordance with appearance characteristics of a conventional connector, thereby increasing utility of the connector.

Preferably, the cable connector 100 of the present invention may further include a sealing member 130. The sealing member 130 is configured to prevent an inflow of impurities such as dust or water. The sealing member 130 may be affixed to an outer periphery of the cable connector 100 and located between the cable connector assembly and the equipment. As shown in FIGS. 1 and 2, the sealing member 130 provides elastic connection, between the cable connector assembly and the equipment by exerting elastic strength of rubber or silicon on a portion of the cable connector 100 contacted with the equipment when the cable connector assembly is connected with the equipment. Since an ordinary person skilled in the art can easily infer and practice the subject matter to which the elastic connection pertains, the detailed description is omitted.

According to the present invention, the cable connector assembly can provide connection between a cable and an equipment as well as between cables. Therefore, the present invention eliminates the need that a connector for a cable and a connector for equipment connection should be manufactured separately, thereby considerably reducing the connector manufacturing costs.

Hereinabove, preferred embodiments of the present invention has been described in detail with reference to the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description.

1-7. (canceled)

8. A cable connector assembly for equipment connection, comprising:
a cable connector including a connector housing, for receiving a cable, and a restraining part formed along an outer periphery of the connector housing; and
an equipment connection unit including a frame body surrounding the outside of the connector housing, an engaging part engaged with the restraining part of the cable connector, and a fastening means formed in the frame body and configured for connection with equipment,
wherein the equipment connection unit provides a flange to connect the cable connector assembly with the equipment.

9. The cable connector assembly for equipment connection according to claim 8, wherein the restraining part has a flange protruding along the outer periphery of the connector housing, and wherein the engaging part has a stepped structure formed along an inner periphery of the frame body so that the flange of the restraining part is fitted into the engaging part.

10. The cable connector assembly for equipment connection according to claim 8, wherein the cable connector further includes a sealing member located between the restraining part and the equipment when the cable connector assembly is connected with the equipment.

11. The cable connector assembly for equipment connection according to claim 8, wherein the frame body is formed to have a square periphery, and wherein the fastening means is a through-hole, through which a bolt is inserted, formed at each corner of the frame body.

12. An equipment connection unit assembled with a cable connector including a connector housing for receiving a cable and a restraining part formed along an outer periphery of the connector housing to provide a flange, the equipment connection unit comprising:
a frame body surrounding the outside of the connector housing;
an engaging part engaged with the restraining part of the cable connector; and
a fastening means formed in the frame body and configured for connection with equipment.

13. The equipment connection unit according to claim 12, wherein the restraining part of the connector housing has a flange protruding along the outer periphery of the connector housing, and wherein the engaging part has a stepped structure formed along an inner periphery of the frame body so that the flange of the restraining part is fitted into the engaging part.

14. The equipment connection unit according to claim 12, wherein the frame body is formed to have a square periphery, and wherein the fastening means is a through-hole, through which a bolt is inserted, formed at each corner of the frame body.
